(19) United States
(12) Patent Application Publication
(10) Pub. No.: US 2012/0296756 A1
(43) Pub. Date: Nov. 22, 2012

(54) COMPUTER APPLICATION FOR SWAPPING ITEMS WITHIN A USER CONTACT NETWORK

(76) Inventor: Kalpesh Shah, Chicago, IL (US)

(21) Appl. No.: 13/474,673

(22) Filed: May 17, 2012

Related U.S. Application Data
(60) Provisional application No. 61/487,259, filed on May 17, 2011.

(51) Int. Cl. G06Q 30/00

(52) U.S. Cl. 705/26.2

(57) ABSTRACT

A computer application that interfaces with a known network to identify and notify users of opportunities to swap or trade items.

### CROSS-REFERENCE TO RELATED APPLICATIONS

The present application claims priority under the laws and rules of the United States, including 35 USC §120, to U.S. Provisional Patent Application No. 61/487,259 filed May 17, 2011. The contents of U.S. Provisional Patent Application No. 61/487,259 are herein incorporated by reference in their entirety.

### FIELD OF THE INVENTION

The present invention is directed to a computer application for use on a personal computer, smartphone or other user interface based computing device and, specifically, to facilitate swapping of goods and services within a user's contact network.

### BACKGROUND

The proliferation of the Internet and personal computing devices has resulted in increased opportunity for web based applications in addition to websites. Many such applications involve social networking, such as Facebook or LinkedIn, or the sale of goods and services, such as Amazon.com or Southwest.com. In each case, an application is available to facilitate use of the Internet-based service on a smartphone. A need remains, however, for an application that allows for the bartering or swapping of goods or services between known users. One of the many challenges of such an application is to eliminate the opportunity for fraud or swindlers. The inventor experienced this through a website, GiftSwap.com, dedicated to web-based swapping for several years beginning in about 2005. The site experienced limited success largely due to the fact that it relied on stranger-to-stranger transactions. There were thus frequent instances of fraud or misunderstanding. Moreover, because the transactions were user to user and involved no payment, there was little, if any, recourse available for fraud or unfair transactions. In other words, since there was not payment through, for example, credit card or Paypal, there was no mechanism for refunds or dispute resolution in the case of incomplete or misrepresented transactions. Further, because the site provided for free transactions it was not reasonable to ask users to post credit card information or deposits. Ultimately, the website was taken offline until a solution could be identified. Accordingly, a solution is thus necessary to allow for user to user swapping without the risk of stranger-to-stranger interaction. A further solution to help reduce misunderstandings with trades and decrease or eliminate transactions costs such as shipping and handling costs in trades is also sought.

### BRIEF SUMMARY

Embodiments of the disclosure achieve these objectives by the different computer application taught herein. Specifically, such a computer application may be for use on a personal computer or smartphone that will interact with the user's contact network, such as phone contacts, Gmail contacts, Facebook contacts, Blackberry Messenger, Foursquare, etc., to identify opportunities for swapping goods or services. The user may select some or all of the members of its contact list to potentially swap with and the application then looks for matches between that group for items sought or for exchange, thus notifying the user of a potential transaction. The user and contact can then communicate directly regarding a potential exchange. Since the user is familiar with the chosen contacts, the risk of fraud or misunderstanding is little to none, and the parties can exchange items with minimal transaction (shipping, etc.) costs. Indeed, the trades can be facilitated or coordinated based on social events or calendars of the user and contacts and they likely have some such events in common or can easily coordinate a meeting.

The foregoing summary is illustrative only and is not intended to be in any way limiting. In addition to the illustrative aspects, embodiments, and features described above, further aspects, embodiments, and features will become apparent by reference to the drawings and the following detailed description

### BRIEF DESCRIPTION OF THE SEVERAL VIEWS OF THE DRAWINGS

The accompanying drawings, which are incorporated in and constitute part of this specification, illustrate embodiments of the invention and together with the description serve to explain the principles of the present disclosure. The embodiments illustrated herein are presently preferred, it being understood, however, that the invention is not limited to the precise arrangements and instrumentalities shown, wherein:

FIG. 1 is an exemplary network architecture diagram showing aspects of the present disclosure that includes one or more computer applications used for swapping items within a user's contact network;

FIG. 2 is a functional block diagram of an exemplary computer server that implements aspects of the present disclosure including one or more computer applications used for swapping items within a user's contact network;

FIG. 3 is a functional block diagram of an exemplary client computing device that implements of the present disclosure including one or more computer applications used for swapping items within a user's contact network;

FIGS. 4-5 are a functional block diagram of aspects of the present disclosure including one or more computer applications used for swapping items within a user's contact network;

FIGS. 6-11 are exemplary screenshots of user interfaces of a computer application for swapping items within a user's contact network;

FIG. 12 describes a preferred embodiment which may be implemented on a personal handheld device or on a computer system such as a desktop, laptop or even server or “cloud” environment.

### DETAILED DESCRIPTION OF THE INVENTION

In the following detailed description, reference is made to the accompanying drawings, which for a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of difference configurations, all of which are explicitly contemplated herein. Further, in the following description, numerous details are set forth to further describe and explain one or more embodiments. These details include system configurations, block module diagrams, flowcharts (including transaction diagrams), and accompanying written description. While these details are helpful to explain one or more embodiments of the disclosure, those skilled in the art will understand that these specific details are not required in order to practice the embodiments.

The preferred and best embodiment envisioned by the inventor is an application for a smartphone device. The application offers various input mechanisms and/or user interfaces for the user to enter goods or services sought or to be exchanged. For instance, the user may identify goods or services by typing in a description, taking a picture of the product, entering or photographing a barcode, selecting the item from a drop box, or even from a description on the Internet. The user has the ability to then set the application to monitor some or all of the user's contacts who also use the application to determine whether a contact has a good or service sought or to be exchanged. When a match or near match is found, the application informs the user and the contact of the potential for a swap.

For example, a user may have a DVD of Movie A but not want it because it is a duplicate, not of interest, or some other reason. Similarly, the user may be interested in obtaining Book B, Movie C and Memory Card D. The user enters through the user interface of his device a description for Movie A as an item offered (i.e., for trade, barter, etc.). The user also enters the other items Book B, Movie C and Memory Card D into the application through the input mechanism/user interface and identifies these items sought. The application taught herein will then periodically compare these lists with those of other users also running the application. If another contact is found that wants A and has B, C or D listed in the contact's “for exchange” category, the user and contact are notified of a potential swap. The user and contact can then confirm a swap and make the necessary arrangements for complete the transaction.

Many variations of the above general concept may be implemented to offer the user a more robust user experience. For example, the user can select to keep matches private such that upon identification of a potential trade, only the user with the item for trade will be notified. This prevents the situation where a user changes his mind or does not want to trade with a particular user from having the contact also of the potential trade.

Similarly, in another variation, the user can be notified if there is any match, not only a like for like match. Thus, for instance, the user can be notified if any contact has Book B, Movie C or Memory Card D, irrespective of whether that contact seeks Movie A. Alternatively, the user may be notified if a contact seeks Movie A even if they don't have Book B, Movie C or Memory Card D as the contact may have something else sought by the user or the contact may elect to purchase or otherwise obtain Book B, Movie C or Memory Card D to exchange for Movie A.

In another variation, the sought and for exchange lists can be published to the user's contact group such that those contacts that use the application can view in their entirety all such items available, either on a contact by contact basis or collectively. This may facilitate general exchanges as opposed to specific exchanges, including multiparty exchange where matches of three or more users may be required.

In another variation, the application may operate on a user's personal computer to interface with their email provider such as Gmail, Lotus Notes or Outlook.

In another variation, the application may run in background on a website such that it will interface with a user's Internet based contacts such as Gmail or Facebook or the computer application may even be offered as a feature as part of Gmail or Facebook. Thus, as a user is using Gmail or Facebook notifications of possible swaps can be provided. In the smartphone context, the Gmail, Facebook or separate application based on this invention could provide notifications, on a real-time basis if preferred, of possible swaps.

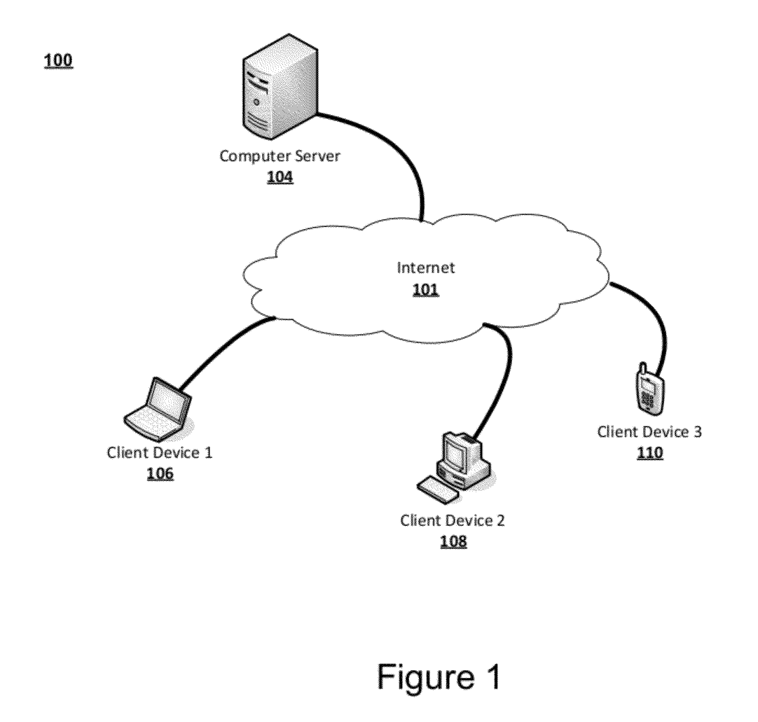

FIG. 1 is an exemplary network architecture diagram 100 showing aspects of the present disclosure including one or more computer (software) applications used for swapping items within a user's contact network. A computer server 104 is coupled to a communication network 101 such as the Internet. Further, client computing devices (106, 108, and 110) are also coupled to the communication network 101 through various means known in the art that include, but are not limited to, wireless, wireline, optical, etc. The client computing devices (106, 108, and 110) may be desktop, laptop, or tablet computers as well as smartphones or other mobile devices. The computer server 104 and each of the client computing devices (106, 108, and 110) may run or execute one or more computer/software applications used for swapping items with a user's contact network. In addition, client computing devices (106, 108, and 110) may include user interfaces to enter descriptions of items a user is willing to swap using the one or more computer applications. This includes both items the user is offering for swap and items the user seeks from a possible swap. The user interface or input mechanisms may include but are not limited to a keyboard, touchscreen, mouse, camera, barcode scanner, drop box or even a separate application like Google Goggles; basically, any means available for entering into the software the items offered and items sought.

Embodiments of the computer application may be implemented based on the client-server model known to a person of ordinary skill in the art. Thus, once item descriptions are captured using the input mechanisms of a client computing device (106, 108, or 110) using one or more client software applications used for swapping items in a user's contact network, the item descriptions may be uploaded or transferred to the computer server 104 across the communication network 101. The computer server 104 may store the item descriptions in one or more databases and associate the item description to the user. Alternatively, this information can be limited to the client computing device and compared with similar information uploaded to the device based on other contacts also using the application.

A user implements the one or more computer applications to swap items with others in the user's contact network. A user's contact network may be downloaded from the user's different contact lists that may include contact stored in an email program (e.g. Outlook, Gmail, Yahoo!, Hotmail, BBM, etc.) as well as social media sites (e.g. Facebook, Twitter, LinkedIn, Foursquare, etc.) or the phone directory of a user's smartphone. Once downloaded, the user's one or more contact lists are uploaded or transferred to the computer server 104 to be stored in one or more databases. The contact list uploaded or transferred may be the user's entire contact list, a selected group of contacts, or a selected group of contact lists. For example, the uploaded or transferred list may be of only those contacts with the application for the invention taught herein, or may be the entire contact list of the user's gmail account.

After receiving user's contact lists, the computer server 104 analyzes the user's contacts using one or more server software applications to determine whether any of them utilize its computer application for swapping items. Typically, each user of the application will have a unique identification code such that upon transfer or upload of the list, the server can identify all accounts connected with a specific user. The one or more server software applications may then determine whether any of the user's contacts have items the user is seeking or items the user is willing to trade. If such a match is determined, then the computer server 104 using its one or more server software applications notifies the user as well as the user's contact(s) of such a match and the one or more server software applications as well as the one or more client software applications facilitates the user and the contact(s) to complete a swap transaction.

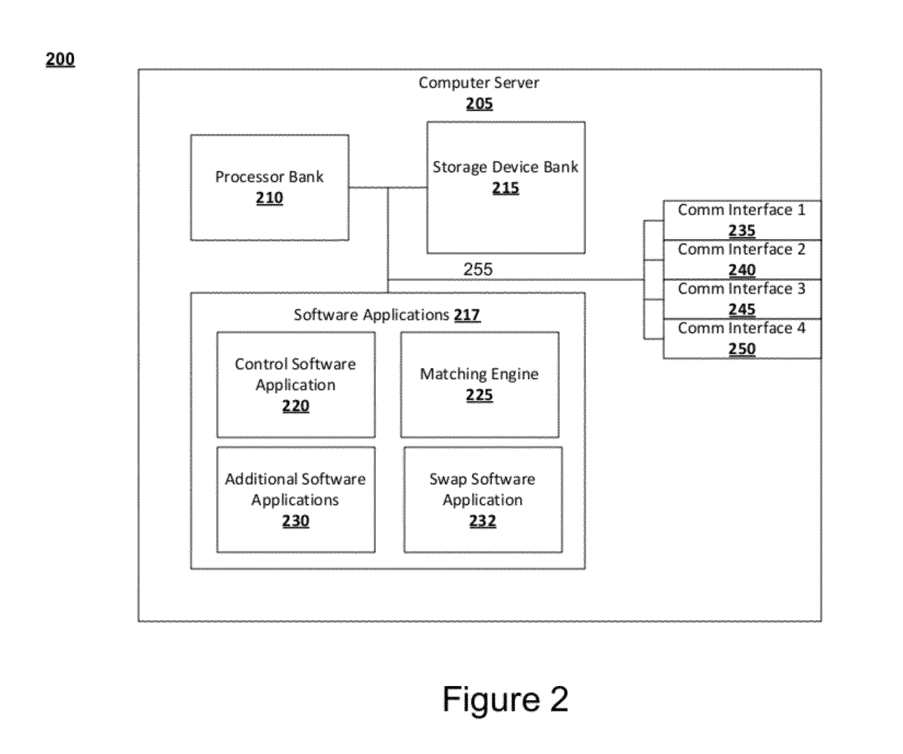

FIG. 2 is a functional block diagram 200 of an exemplary computer server 205 that implements aspects of a computer application for swapping items within a user's contact network. The computer server 205 may include several different components such as a processor bank 210, storage device bank 215, one or more software applications 217, and one or more communication interfaces (235-250). The processor bank 210 may include one or more processors that may be co-located with each other or may be located in different parts of the computer server 205. The storage device bank 215 may include one or more storage devices. Types of storage devices may include memory devices, electronic memory, optical memory, and removable storage media. The one or more software applications 217 may include control software applications 220, a matching engine 225, and additional software applications 330. The control software applications may implement software functions that assist in performing certain tasks for the computer server 205 such as providing access to a communication network, executing an operating system, managing software drivers for peripheral components, and processing information. The additional software applications may include software drivers for peripheral components, user interface computer programs, debugging and troubleshooting software tools. The matching engine 225 implements aspects of a computer application for swapping items within a user's contact network. The swap software application 232 receives and processes a user's contact list.

Specifically, the swap software application 232 receives a user's contact list from a client software application running on a user's client computing device. If the contact list is broader than those contacts also using the invention herein, the swap software application 232 analyzes the user's contacts which may be located as part of one or more user contact lists each list may be from a user's different social network (e.g. email, gmail, yahoo, hotmail, Facebook, Twitter, LinkedIn, etc.). In addition, the swap software application 232 may analyze the contents of the storage device bank (which may include one or more databases) to determine whether any of the contacts on the user's contact lists utilize the computer application for swapping items. If so, the swap software application 232 stores the user's contact in the one or more databases and associates those contacts also using the computer application for swapping items.

A further embodiment may include the swapping software application 232 receiving a user's swap list (items a user is willing to trade) and sought list (items a user is seeking) and storing the user's swap and sought lists in one or more databases.

Another embodiment may include the swap software application 232 receiving a request from a client software application running on a client computing device for retrieving a user's contacts and the items each contact is seeking and willing to trade. In response to such a request, the computer server analyzes the one or more databases to determine the user's contacts as well as each contacts' items sought and items willing to trade.

Further, in one embodiment, the matching engine 225 analyzes items a user is willing to trade and compares the items to items the user's contacts are seeking. In another embodiment, the matching engine analyzes items a user is seeking and compares the items to items the user's contacts are willing to trade. If there is a match, matching engine notifies the one or more client software applications of the match so that the user and the user's contact may complete the swap transaction.

Additional software application 230 may also provide such functions as receiving message and/or notifications from a user's client computing device and relayed to a contact's client computing device. Such messages and/or notifications may include a user's swap proposal, a contact's counter proposal, or any other inquiries and/or messages.

Each of the communication interfaces (235-250) shown in FIG. 2 may be software or hardware associated in communicating to other devices. Indeed, one of skill in the art would understand that the various software components taught herein can reside all on a server, all on a mobile device, or some combination of both. The communication interfaces (235-250) may be of different types that include a user interface, USB, Ethernet, WiFi, WiMax, wireless, optical, cellular, or any other communication interface coupled to communication network.

An intra-device communication link 255 between the processor bank 210, storage device bank 215, software applications 225, and communication interfaces (230-245) may be one of several types that include a bus or other communication mechanism.

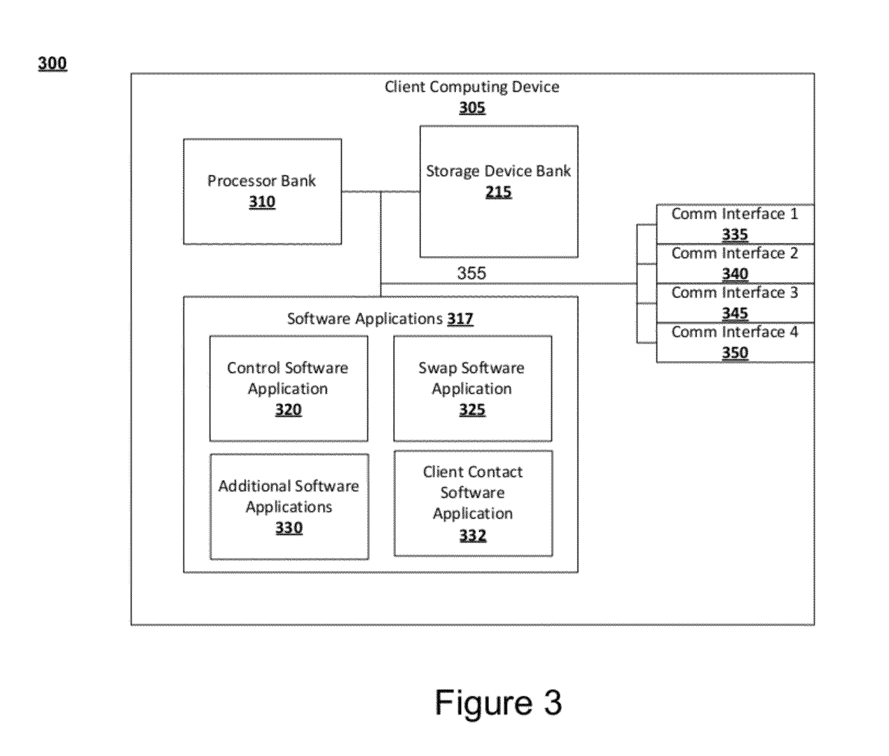

FIG. 3 is a functional block diagram 300 of an exemplary client computing device 305 that implements aspects of a computer application for swapping items within a user's contact network. The client computing device 305 may include several different components such as a processor bank 310, storage device bank 315, one or more software applications 317, and one or more communication interfaces (335-350). The processor bank 310 may include one or more processors that may be co-located with each other or may be located in different parts of the client device 305. The storage device bank 315 may include one or more storage devices. Types of storage devices may include memory devices, electronic memory, optical memory, and removable storage media. The one or more software applications 317 may include a control software application 320 implementing software functions that assist in performing certain tasks for the client computing device 305 such as providing access to a communication network, executing an operating system, managing software drivers for peripheral components, and processing information. The client contact software application 332 allows a user to download user's contacts from different social media (email, gmail, Yahoo mail, hotmail, Facebook, twitter, LinkedIn, etc.). Further, the client contact software application 332 may transfer the user's contact list to a computer server across the Internet. Additional software applications 330 may include software drivers for peripheral components, user interface computer programs, debugging and troubleshooting software tools.

The client computing device 305 may also include swap software application 325 that receives notifications from a computer server that a user's contact has either an item the user is seeking or that the contact is seeking an item the user is willing to trade. Further, the swap software application may allow the user to complete the swap transaction with the user's contact using software tools.

Additional functions for the client contact software application 332 may include allowing a user to browse a specific contact's or a group of specific contact's items sought and items for trade. An embodiment may include the client contact software application 332 sending a request to the computer server for the user's contacts that utilize the computer application for swapping items as well as each contact's items sought and items for trade. Further, the client contact software application 332 receives the user's contacts that utilize the computer application for swapping items as well as the sought and trade items associated with each contact. The user may then browse the contact's items to determine whether there may be a swap match between the user's items and the contact's items. A matching engine on the mobile device or on a server may also perform this function and identify matches, including matches based on combinations of three or more contacts. If a swap opportunity is identified, the swap software application 325 may be used to facilitate the swap transaction. Such functions may include sending a proposed swap transaction to the contact across the Internet or other network to the contact's client computing device.

Each of the communication interfaces (335-350) shown in FIG. 3 may be software or hardware associated in communicating to other devices or to a web server user. The communication interfaces (335-350) may be of different types that include a user interface, USB, Ethernet, WiFi, WiMax, wireless, optical, cellular, or any other communication interface coupled to communication network.

An intra-device communication link 355 between the processor bank 310, storage device bank 315, software applications 317, and communication interfaces (335-350) may be one of several types that include a bus or other communication mechanism.

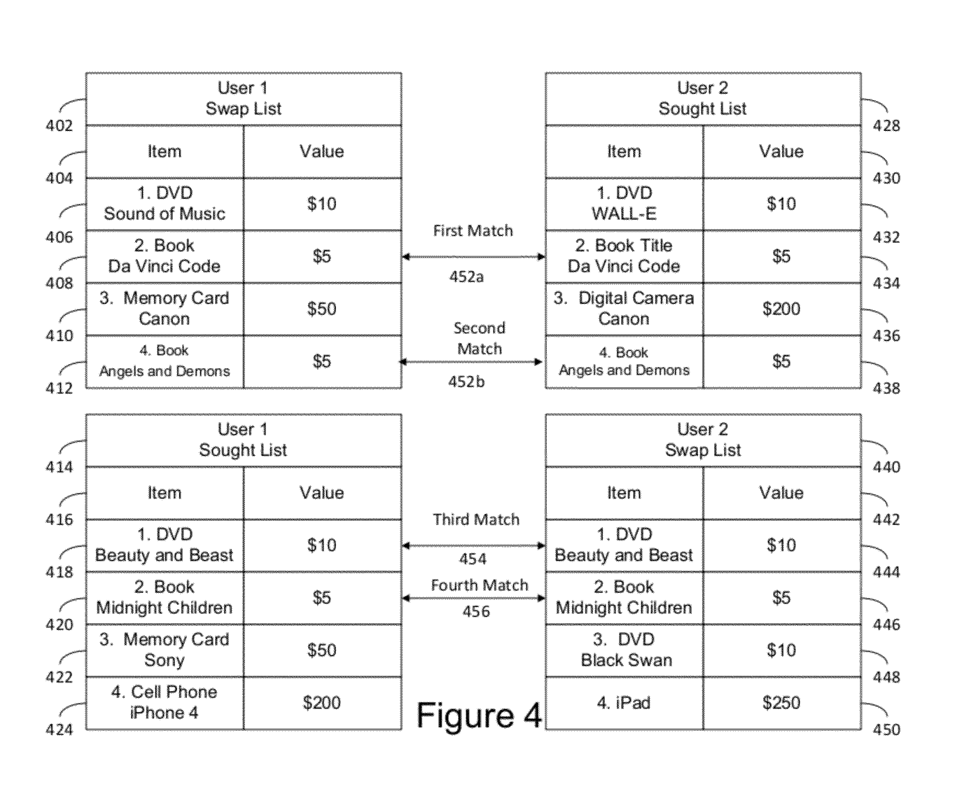

FIG. 4 is a functional block diagram that shows aspects of the present disclosure including a computer application for swapping items within a user's contact network. In the embodiment shown in FIG. 4, User 1 may enter a swap list 402 into the computer application that includes several items 404 such as a DVD 406, Book 408, a Memory Card 410, and another book 412. Further, User 1 may enter a value associated with each item (404-412). In addition to the swap list 402, User 1 may enter a sought list into the computer application 414 that includes several items 416 such as a DVD 418, a Book 420, a memory card 422 and a cell phone 424. Also, User 2 may enter a sought list 428 into the computer application that includes several items 430 such as a DVD 432, Book 434, a Digital Camera 436, and another book 438. Further, User 2 may enter a value associated with each item (430-438). In addition to the sought list 428, User 2 may enter a swap list into the computer application 440 that includes several items 442 such as a DVD 444, a Book 446, a another DVD 448 and a tablet computer 450. Users 1 and 2 may enter the textual/visual description of the items using a variety of input mechanisms/user interfaces known in the art. Further, persons of ordinary skill in the art understand that the computer application may include one or more server software applications or engines residing and executed on a computer server as well as one or more client software applications or engines residing and executed on a client computing device.

A matching engine of the computer application may process and analyze the items on users' swap lists with other users' sought lists. In the preferred embodiment, the matching engine compares the sought and swap lists to determine if there is a first match 452a and a second match 452b between items on the User 1 swap list 402 and User 2 sought list 428. That is, User 1 has two books for swap (408 and 412) that are sought by User 2 (434 and 438). The matching engine determines the first match 452a and the second match 452b by comparing the title of the items listed in User 1's swap list with the title of the items listed in User 2's swap list. Subsequently, the matching engine may process and analyzes items on the User 2 swap list and determine whether there is a third match 454. If the exact items for trade and sought do not match, the matching engine may also determine a value for each item as well as the collective value of the items. That is, the third match 454 may be for one item that has a value equal to the sum of the value of the items in the first match 452a and second match 452b collectively. In FIG. 4, the second match 454 is for a DVD that has a value equal to the collective value of the two books in the first match (452a and 452b). Alternatively, the first match 452a may be for items that have a value equal to items in a fourth match 456.

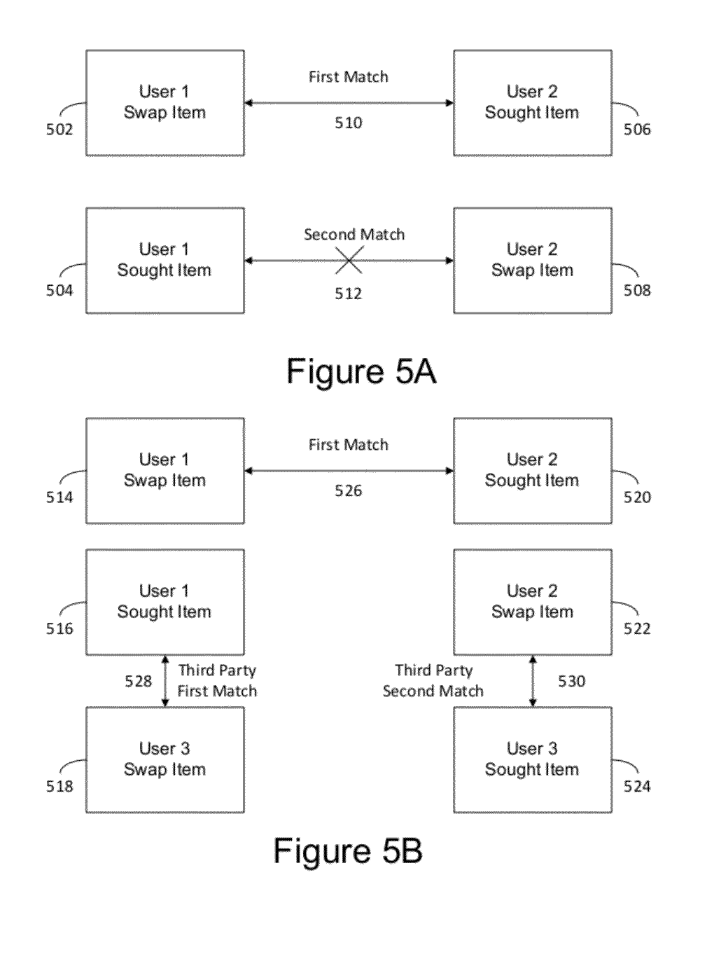

FIGS. 5A and 5B are functional block diagrams of aspects the present disclosure that includes a computer application for swapping items within a user's contact network. A matching engine of the computer application may process and analyze the items in various user's swap lists and try to match them to items in other users' sought lists. In one embodiment, the matching engine determines a first match 520 between a swap item 502 on a User 1 swap list and a sought item 504 on a User 2 sought list. Subsequently, the matching engine determines whether there is a second match 512, e.g., as illustrated here there is no item 508 in the swap list of User 2 that matches item 504 on the sought list of User 1. Referring to FIG. 5B, if no second match is found, the matching engine processes and analyzes the swap and sought lists of other contacts in the user's list. Further, the matching engine may determine that a User 1 sought item 516 may be a match 528 with a User 3 swap item 518. In addition, a User 2 swap item 522 may be a second match 530 with a User 3 sought item 524. As such, the computer application can facilitate a three-party swap between User 1, User 2, and User 3 by notifying each user of the possible swap transaction and if accepted by each user assist in completing the swap transaction.

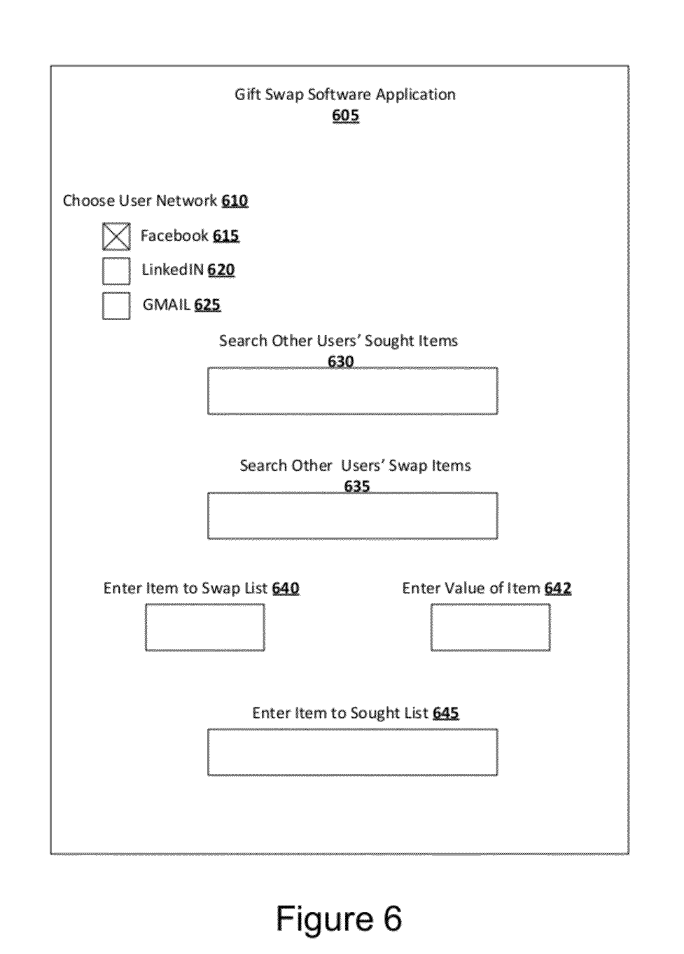

FIGS. 6-11 are exemplary screenshots of user interfaces of a computer application for swapping items within a user's contact network. Referring to FIG. 6, a screenshot of a gift swap application 605 is shown. Such a screenshot 605 and screenshots shown in the subsequent figures may be displayed on an user interface of client computing device such as a desktop or laptop computer or a mobile software application displayed on a mobile phone. The screenshot 605 may include several check boxes (615-625) and dialog boxes (630-645) to allow a user provide user input. As part of the gift swap software application, a user may choose one or more user networks to swap gifts among the user's contacts. This may include social media contacts stored by social media sites such as Facebook and LinkedIn as well email contacts stored by email services like Gmail and Yahoo! Email. In FIG. 6, a user has selected Facebook contacts 615 to be the user network to swap gifts among. Thus, a client software application downloads the user's contact list from the social media site and transmits the user's contact list to a computer server that stores such a user's contact list in one or more databases.

Further, a user may enter an item that other users are seeking in the “Search Other users' Sought Items” dialog box 630. In addition, a user may enter an item that other users are willing to trade in the “Search Other users' Swap Items” dialog box 635. Another dialog box shown on screenshot 605 is “Enter Item to Swap List” 640 as well as the value of such an item 642. Also, a user may enter an item on the user's sought list 645. These dialog boxes are examples of input mechanisms/user interfaces that allow user to enter items that the user is willing to trade as well as items the user is seeking. Such items may then be transmitted by the client software application to a computer server to be stored in one or more databases.

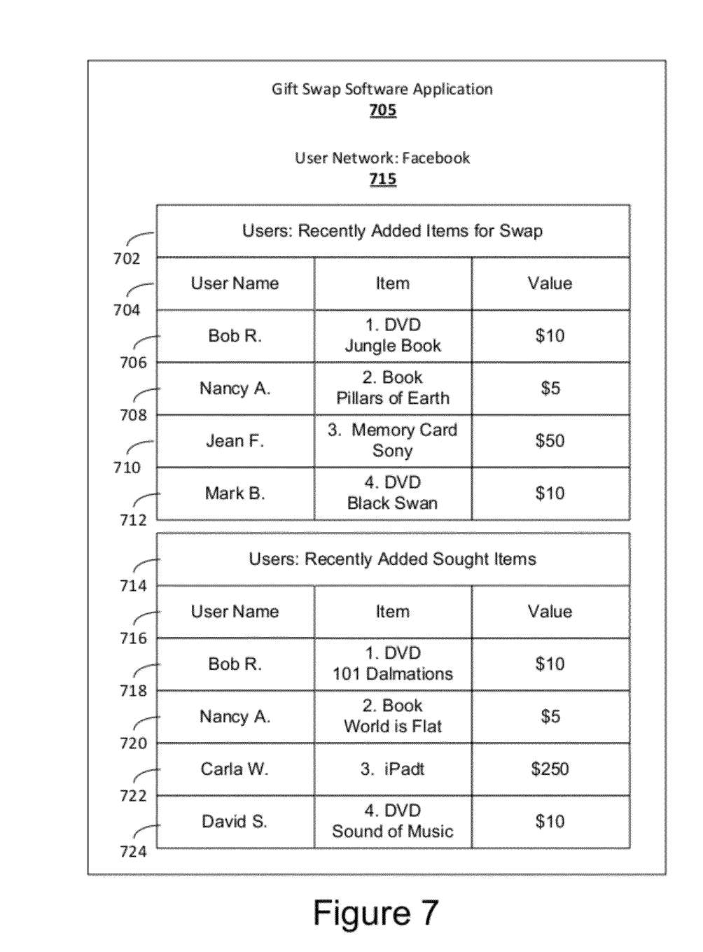

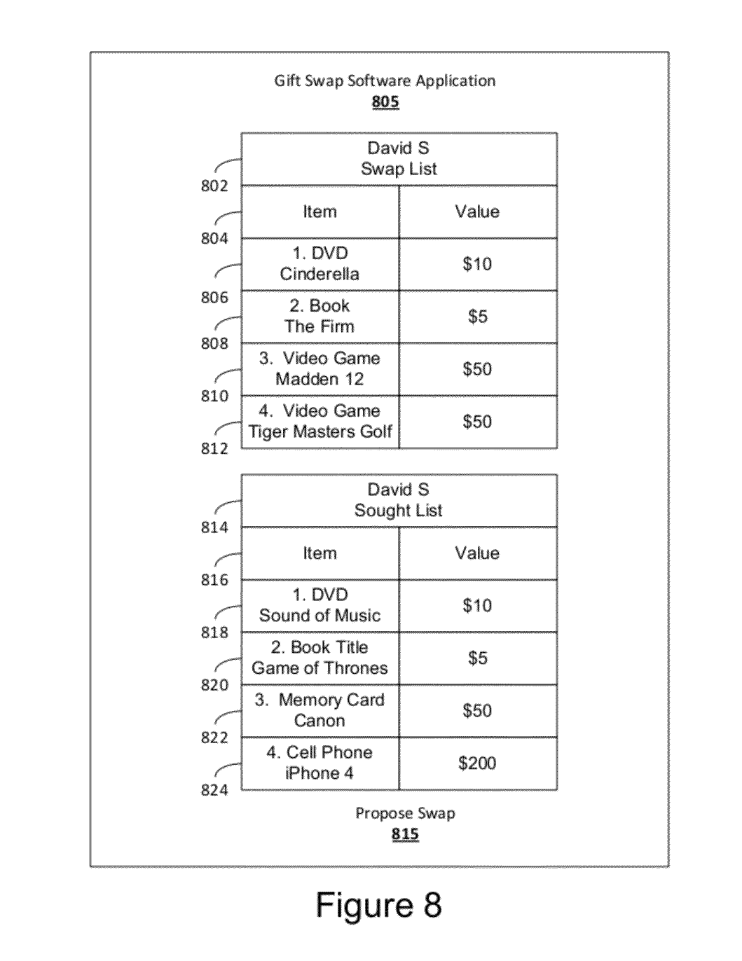

Referring to FIG. 7, a screenshot 705 of the gift swap software application is shown. The screenshot 705 lists the user network, i.e., a grouping of contact list members that use the computer application taught herein, the user has chosen to view for this session. The screenshot 705 lists the user network in which gift are swapped (715). Note, if user has configured the gift swap software application running on the user's client computing device accordingly, the screenshot 715 may list more than one user network. In the embodiment shown in FIG. 7, the user's contact network is contacts from a social media website (e.g. Facebook). A table on the screenshot 705 may include a list of users that recently added items to their respective swap lists 702. The table 702 includes a User Name, Item and Value of the Item 704 for four different users (706-712). Further, another table on the screenshot 705 may include a list of users that recently added items to their respective sought lists 714. The table 714 includes a User Name, Item and Value of the Item 704 for four different users (716-724). The name of each user (706-724) in either table (702 and 714) may be associated with a hypertext link. Clicking a user name may cause a user interface to display a screenshot such as one shown in FIG. 8. As one of skill in the art would recognize, there are many iterations of data that may be shown on such a screen such as by user, by items, by value, by activity, etc. The tables shown here are illustrative of some such examples but in no way meant to be limiting.

In one embodiment, the items in the listed on screenshot 705 are transmitted by the internet or other network to the gift swap software application running on a computer server. The computer server implements one or more software applications that stores in a separate portion of memory recently added items to any user's swap lists or sought lists. Swap lists contain items a user is willing to trade and sought lists contain items a user is seeking. The computer server may have a configurable parameter to save recently added items to any user's swap or sought lists for period of time or until a threshold number of quantities are reached. It also will remove items and update items on the user and contact lists as necessary. When a client computing device requests the most recently added swap and sought items for any user, the computer server transmits such stored items from the separate memory. In an alternative embodiment, the application and matching engine may reside entirely on the mobile device network.

Referring to FIG. 8, a selected user contact's swap list 802 and sought list 814 is shown. In the embodiment shown in FIG. 8, the user contact's swap list 802 may contain four items and each item's associated value (804-812). Further, the user contact's sought list 814 is shown containing four items and each item's associated value (816-824). After browsing the user's contact's swap and sought lists, the user may make a swap proposal to the contact.

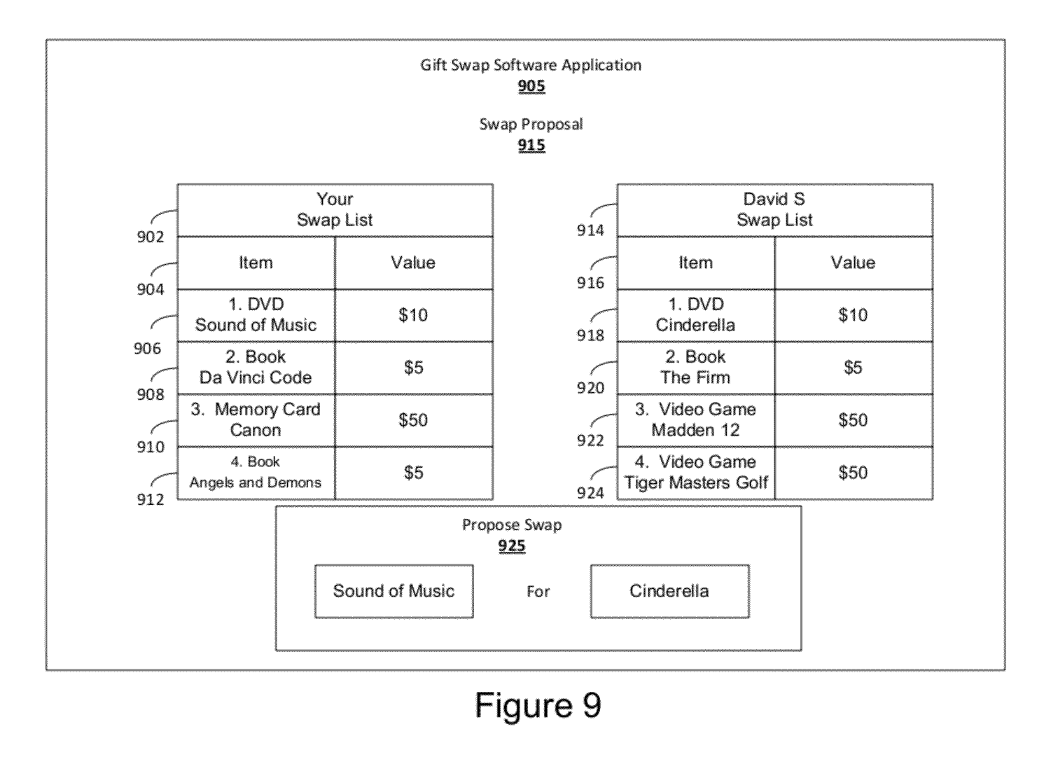

Referring to FIG. 9, a screenshot 905 facilitates a swap proposal 915 between a first user and a second user. The screenshot 905 may include two tables (902 and 914). A first table 902 may be a first user's swap list and a second table 914 may be a second user's swap list. The first user may browse the second user's swap list and find an item not on the first user's sought list (not shown) but that is an item that the first user may still consider accepting in a swap. Further, there may be an item on the first user's swap list that 902 may be of interest to the second user even though the item is not on the second user's sought list (not shown). Thus, by proposing a swap, the first user may come across a match that may not have been found by a matching engine of the gift swap computer application. The screenshot 905 may have a Propose Swap dialog box 925 such that the first user may enter items for the proposed swap (e.g. Sound of Music DVD for Cinderella DVD). The proposed swap can be input in many ways known in the art such as touching the two items of interest on a touchscreen, entering corresponding item identification numbers in a dialog box, etc.

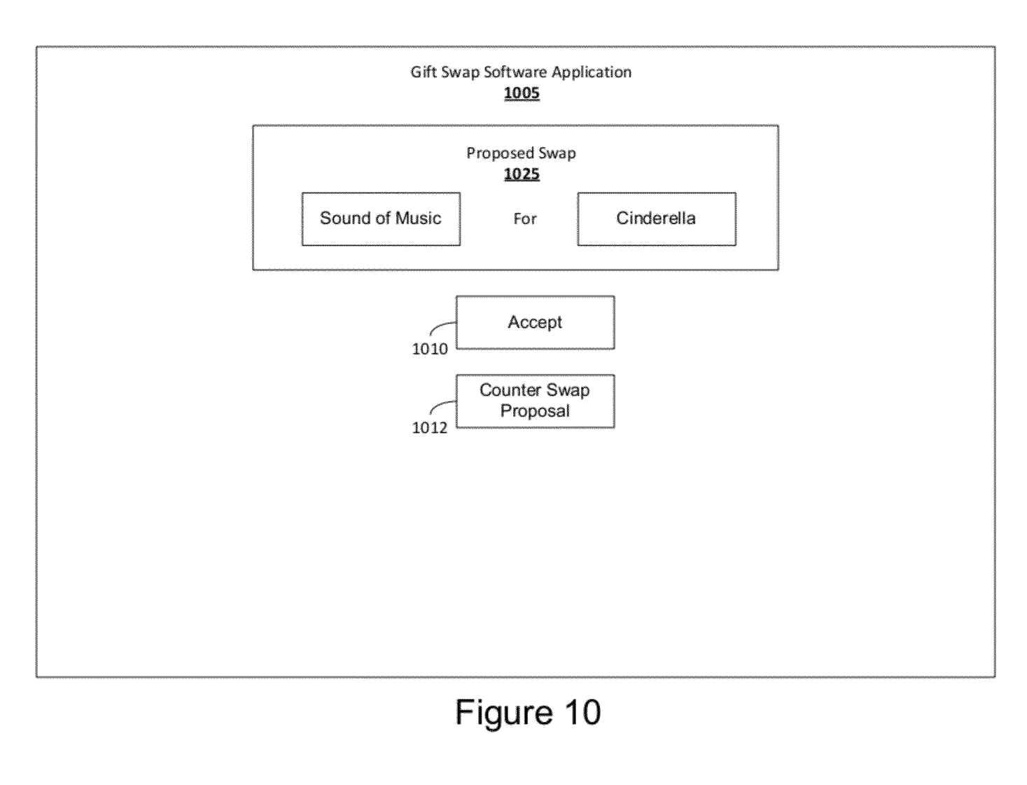

Referring to FIG. 10, a screenshot 1005 may be shown on a user interface of a client computing device of the second user from FIG. 9 displaying a proposed swap 1025 (e.g. Sound of Music DVD for Cinderella DVD). The screenshot 1005 may have a push button 1010 that allows the second user to accept the proposed swap or another push button 1012 to provide a counter swap proposal. Selecting the counter swap proposal push button 1012 may cause a screenshot similar to FIG. 9 to be displayed on the second user interface.

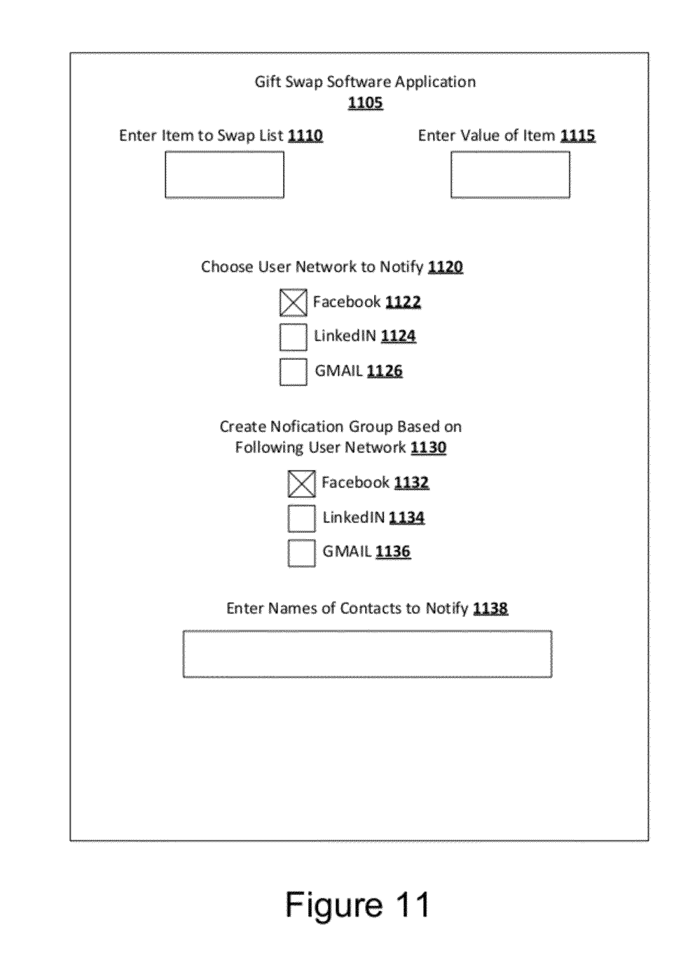

Referring to FIG. 11, a screenshot 1105 allows a user to enter an item to a user's swap list 1110 as well as the value of the item 1115. Further, the user may select one or more contact networks to be notified of the recently added swap item using one or more check boxes (1120-1126) on the screenshot 1105. Such a notification may be an email to the user's contacts with the selected user networks or a text alert or some other messaging system known in the art. In addition, a user may generate a custom notification group from contacts of one or more user networks (1130-1136). Once a user network is selected (1130-1136) a user may enter the name of the contact into a dialog box 1138. After entering the names of the contacts, a notification of the added swap item is sent to the group of contacts. Such a notification may be an email to the user's contacts with the selected user networks or a text alert or some other messaging system known in the art. The same process can be implemented for new items added to the sought list as well.

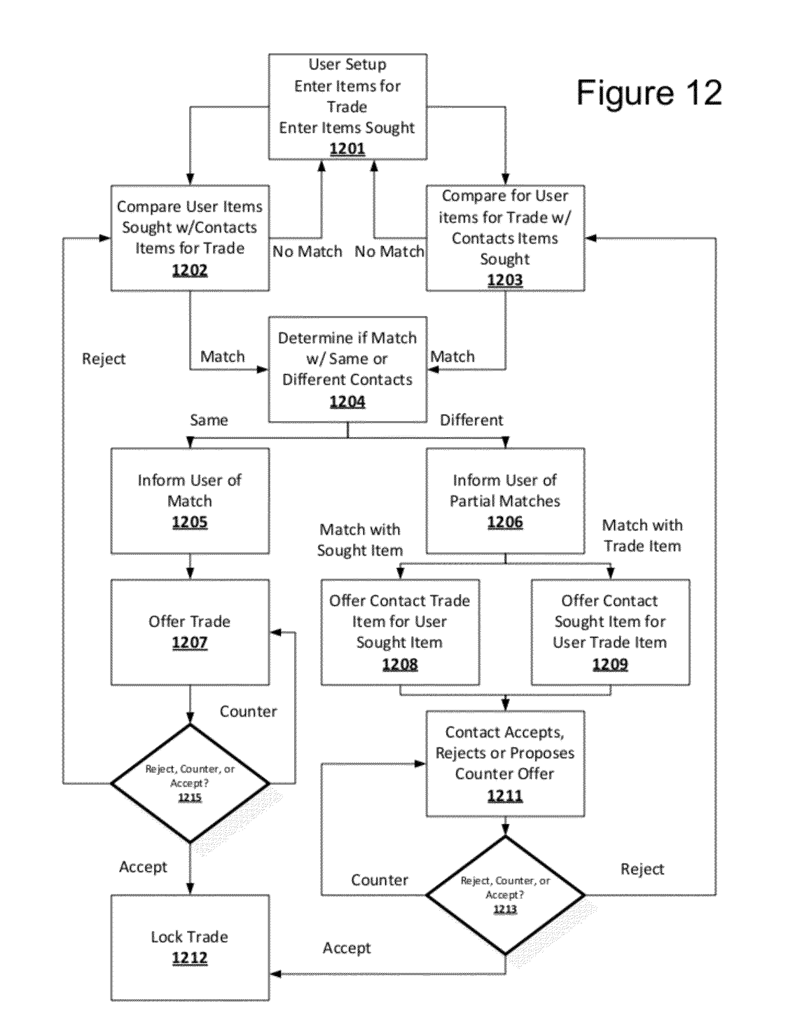

FIG. 12 describes the preferred embodiment which may be implemented on a personal handheld device or on a computer system such as a desktop, laptop or computer server or “cloud” environment. In such an embodiment, a user sets up an account with general user profile information. The user can then access the account and enter in items which the user offers for trade and/or enters in items sought by the user 1201. The system then compares these items with those in the corresponding fields of the user's contacts also using embodiments of the present disclosure. The contact list from which these users can be identified was set by the user as part of the setup as, for example, all or part of the user's phone contacts, the user's email contact list, the user's Facebook friends or other such contacts. The system may then compares the items sought by the user with the items for trade by the user's contacts 1202. The system also compares items for trade by the user with the items sought by the user's contacts 1203. If there is no match, the system will perform this analysis again upon a change in the user's or any contact's account, upon request, or based on some other trigger (e.g., connection to network, power on, pre-set time period, etc.). If matches are identified 1204, the system then determines whether any single contact has a match for both an item sought by the user and an item for trade by the contact and an item for trade by the user which is sought by the same contact. Any such match are identified with a priority to the user 1205. In addition, the system may inform the user of any partial matches, that is matches for an item sought by the user and an item for trade by a contact, and an item for trade by the user which is sought by the different contact 1206.

In the case of match where there is match between a user and one contact (that is a sought item by the user is available for trade by the contact, and a sought item by the contact is available by the user), the system then allows the user to offer a trade with the contact 1207. The contact may then reject, counter offer, or accept the trade 1215. If the trade is accepted, then the system locks trade 1212. If the contact provides a counter offer, then the system provides the counter offer to the user 1207. Alternatively, if the offer is rejected, the system may then compare items sought by the user with the contacts' items for trade 1202.

In the event there are items are matched with different contacts (e.g. partial matches), the user may select any combination of offers or facilitate an alternate trade with one or more contacts. Referring to FIG. 5B, the matching engine processes and analyzes the items for trade and items sought lists for the user's contacts. Thus, User 1 trade item 514 may have a partial match 526 with User 2 sought item 520. Further, the matching engine may determine that a partial match such that User 1 sought item 516 may be a match 528 with a User 3 trade item 518. In addition, another partial match may be User 2 trade item 522 matching 530 with a User 3 sought item 524. As such, the computer application can facilitate a three-party trade between User 1, User 2, and User 3 by notifying each user of the possible trade transaction and if accepted by each user assist in completing the three party trade.

Moreover, if there is partial match between a user sought item and a contact's trade item, the system allows the user to make an offer for the trade item to the contact 1208. Alternatively, if there is partial match between a contact sought item and a user's trade item, the system allows the user to make an offer for the sought item to the contact 1209.

If the partial matches is with respect to a user's for trade item (i.e., a match between the user's for trade and one or more contacts' sought item), the user can then make an offer to the contact of one of the user's for trade items 1209. The contact is then informed of the offer and is given the option to accept, reject or provide a counter offer to the trade 1211. The contact through its client computing device, sends a response with the accept, reject, or counter offer. The remote computer server receives the response and determines the type of response 1213 (e.g. accept, reject, or counter offer). If accepted, the system confirms the trade by locking the items such that they are no longer identifies as part of the inventory and confirmatory notices is sent 1212. If the trade is rejected the process begins again 1203. If a counter offer is made, the user is made give the option to reject or accept or counter 1211. Once a trade is confirmed, the user and one or more contacts can then facilitate a meeting to complete the exchange.

When the one or more contacts receive the offer, they are given the option to accept, reject or counter the trade offer. If the trade is accepted, the items are locked out of inventory such that they will no longer be identified in future searches for the user or the one or more contacts, and confirmatory notice is sent to all involved in the trade 1212. If the trade is rejected, the process begins again. A setting can be included to ignore matches based on rejected trade offers.

Note that the functional blocks, methods, devices and systems described in the present disclosure may be integrated or divided into different combination of systems, devices, and functional blocks as would be known to those skilled in the art.

In general, it should be understood that the circuits described herein may be implemented in hardware using integrated circuit development technologies, or yet via some other methods, or the combination of hardware and software objects that could be ordered, parameterized, and connected in a software environment to implement different functions described herein. For example, the present application may be implemented using a general purpose or dedicated processor running a software application through volatile or non-volatile memory. Also, the hardware objects could communicate using electrical signals, with states of the signals representing different data.

It should be further understood that this and other arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, combinations, screen presentations, or other implementations, which, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A system for electronically coordinating trading of one or more items with members of a user's predefined contact group, the system comprising:
a communication network;
a remote computer server coupled to the communication network;
a database coupled to the remote computer server storing a profile of one or more users, a representation of one or more items available for trade, and a representation of one or more items sought, the database associating the profile with each representation;
a matching engine implemented by the remote computer server, the matching engine capable of comparing and identifying matches of the representation of one or more items available for trade by a user with the representation of one or more items sought by one or more members of the user's predefined contact group;
one or more client computing devices coupled to the remote computer server through the communication network;
wherein the remote computer server transmits item matches identified by the matching engine to the one or more client computing devices.

2. The system of claim 1, wherein the matching engine capable of comparing and identifying:
a first match of the representation of one or more items available for trade by the user with the representation of one or more items sought by a first member of the user's predefined contact group;
a second match of the representation of one or more items available for trade by the first member with the representation of one or more items sought by a second member of the user's predefined contact group; and
a third match of the representation of one or more items available for trade by second member with the representation of one or more items sought by the user.

3. The system of claim 2, wherein the remote computer server transmits:
the first match to a first client computing device and a second client computing device associated with the first user and first member, respectively;
the second match to a second client computing device and third client computing device associated with the first member and second member, respectively; and
the third match to the first client computing device and third client computing device associated with the first user and second member, respectively.

4. The system of claim 1, wherein:
the remote computer server notifies a client computing device an item match and the client computing device provides a response based on the item match;
the response can be selected from the group consisting of accept, reject, or counter;
the remote computer server receives the response and locks the item match if the response is accept.

5. The system of claim 4, wherein the one or more client computing devices are capable of entering a representation using an input method wherein the input method can be selected from the group consisting of product image capture, bar code scan, text input, voice input, touchscreen and combination thereof.

6. The system of claim 1, wherein the one or more client computing devices can be selected from the group consisting of a personal computer, a laptop computer, a smartphone, a tablet computer, a web-enabled television, or a combination thereof.

7. The system of claim 1 wherein the user's predefined contact group can be selected from the group consisting of a social media contact group, professional contact group, an email contract group, mobile device contact group or a combination thereof.

8. A system for electronically coordinating trading of one or more items with members of a user's predefined contact group, the system comprising:
a communication network;
a remote computer server coupled to the communication network;
a database coupled to the remote computer server, the database storing a representation of one or more items available for trade in an items-offered list and a representation of one or more items sought in an items-sought list, each representation associated with a user;
a matching engine implemented by the remote server capable of comparing and identifying matches of the representation of one or more items in the items-offered list of the user with the representation of one or more items in the items-sought list of one or more members of the user's predefined contact group;
one or more client computing devices coupled to the remote computer server through the communication network, wherein the remote computer server transmits item matches identified by the matching engine to the one or more client computing devices.

9. The system of claim 8, wherein the matching engine capable of comparing and identifying:
a first match of an item in the items-offered list of the user with an item in the items-sought list of a first member of the user's predefined contact group;
a second match of an item in the items-offered list of the first member with the an item in the items-sought list of a second member of the user's predefined contact group; and
a third match of an item in the items-offered list of second member with an item in the items-sought list of the user.

10. The system of claim 9, wherein the remote computer server transmits:
the first match to a first client computing device and a second client computing device associated with the first user and first member, respectively;
the second match to a second client computing device and third client computing device associated with the first member and second member, respectively; and
the third match to the first client computing device and third client computing device associated with the first user and second member, respectively.

11. The system of claim 8, wherein:
the remote computer server notifies a client computing device an item match and the client computing device provides a response based on the item match;
the response can be selected from the group consisting of accept, reject, or counter;
the remote computer server receives the response and locks the item match if the response is accept.

12. The system of claim 11, wherein the one or more client computing devices are capable of entering a representation using an input method wherein the input method can be selected from the group consisting of product image capture, bar code scan, text input, voice input, touchscreen and combination thereof.

13. The system of claim 8, wherein the one or more client computing devices can be selected from the group consisting of a personal computer, a laptop computer, a smartphone, a tablet computer, a web-enabled television, or a combination thereof.

14. The system of claim 8 wherein the user's predefined contact group can be selected from the group consisting of a social media contact group, professional contact group, an email contract group, mobile device contact group or a combination thereof.

15. A method for electronically coordinating trading of one or more items with members of a user's predefined contact group, the method comprising:
storing a representation of one or more items available for trade in an items-offered list and a representation of one or more items sought in an items-sought list in a database coupled to a remote computer server, each representation associated with a user;
comparing and identifying matches of the representation of one or more items in the items-offered list of the user with the representation of one or more items in the items-sought list of one or more members of the user's predefined contact group by a matching engine implemented by the remote computer server; and
transmitting item matches identified by the matching engine to the one or more client computing devices coupled to the remote computer server through a communication network.

16. The method of claim 15, further comprising comparing and identifying by the matching engine:
a first match of an item in the items-offered list of the user with an item in the items-sought list of a first member of the user's predefined contact group;
a second match of an item in the items-offered list of the first member with the an item in the items-sought list of a second member of the user's predefined contact group; and
a third match of an item in the items-offered list of second member with an item in the items-sought list of the user.

17. The method of claim 16, further comprising transmitting by the remote computer server:
the first match to a first client computing device and a second client computing device associated with the first user and first member, respectively;
the second match to a second client computing device and third client computing device associated with the first member and second member, respectively; and
the third match to the first client computing device and third client computing device associated with the first user and second member, respectively.

18. The method of claim 15, further comprising:
notifying, by a remote computer server, a client computing device an item match and the client computing device provides a response based on the item match wherein the response can be selected from the group consisting of accept, reject, or counter;
receiving the response by the remote computer server and locks the item match if the response is accept.

19. The method of claim 18, further comprising sending, by the remote computer server, a notification to the one or more client computing devices when the items-offered list of the user and the items-sought of the user is modified by the remote computer server;

20. The method of claim 15, wherein:
the one or more client computing devices can be selected from the group consisting of a personal computer, a laptop computer, a smartphone, a tablet computer, a web-enabled television, or a combination thereof; and
the user's predefined contact group can be selected from the group consisting of a social media contact group, professional contact group, an email contract group, mobile device contact group or a combination thereof.
